(19) United States
(12) Patent Application Publication
(10) Pub. No.: US 2023/0417037 A1
(43) Pub. Date: Dec. 28, 2023

(54) FLUIDIC OSCILLATORS

(71) Applicant: Kohler Co., Kohler, WI (US)

(72) Inventors: Daniel N. Halloran, Fredonia, WI (US); Tony L. Lambert, Sheboygan, WI (US); Cody Wilcox, Cedarburg, WI (US)

(21) Appl. No.: 18/212,005

(22) Filed: Jun. 20, 2023

Related U.S. Application Data
(60) Provisional application No. 63/355,908, filed on Jun. 27, 2022.

(51) Int. Cl. E03D 5/016

(52) U.S. Cl. CPC E03D 5/016

(57) ABSTRACT

A water rinsing system for a toilet includes a fluidic module, a water supply conduit, and a bend connector. The fluidic module is configured to direct water to a toilet bowl. The water supply is configured to supply water to the fluidic module at a rim of the toilet bowl from a water source. The bend connector is configured to connect the fluidic module and the water supply at an angle to overhang the rim of the toilet bowl.

This application claims priority benefit of Provisional Application No. 63/355,908 filed Jun. 27, 2022, which is hereby incorporated by reference in its entirety.

### FIELD

The present disclosure relates generally to plumbing fixtures with water delivery functionality. More specifically, the present disclosure relates to the application of fluidics devices to improve performance of plumbing fixtures.

### BACKGROUND

Commercial and residential plumbing fixtures such as toilets, faucets, showers, whirlpool tubs, and urinals rely on continuous stream flows (e.g., steady-state flows, etc.) of water to perform working operations. For example, toilets rely on the continuous streams of water from a rim or a sump of a toilet bowl to clean the surfaces of a toilet bowl and to remove waste from the toilet bowl during a flush. Similarly, faucets and sprayers utilize a continuous stream of water to provide cleaning action. However, continuous stream flows are not always effective at achieving the intended goals of the product. In the toilet example, continuous stream flows may not be enough to remove all of the waste from the toilet bowl or to fully clean the surfaces of the toilet bowl. Larger volumes of water or higher intensity flows may be required to ensure sufficient cleaning capabilities are provided by the plumbing fixtures.

Many plumbing fixtures also include valves for controlling multiple independent jets. For example, a toilet may include a rim jet in a rim of the toilet bowl and a sump jet in a sump of the toilet bowl. The toilet may include electronic valves that coordinate the release of water from the rim jet and the sump jet. However, these electronic valves typically have many moving parts and the valve and associated control circuits are expensive to manufacture.

### BRIEF DESCRIPTION OF THE DRAWINGS

Exemplary embodiments are described herein with reference to the following drawings, according to an exemplary embodiment.

FIG. 1 illustrates a front view of a toilet including a fluidic oscillator.

FIG. 2 illustrates a rear view of a toilet including a fluidic oscillator.

FIG. 3 illustrates the fluidic oscillator of FIGS. 1 and 2.

FIG. 4 illustrates an example modular fluidic oscillator layout.

FIGS. 5, 6 and 7 illustrate another embodiment of a fluidic oscillator.

FIGS. 8-13 illustrate another embodiment of a fluidic oscillator installation through the bottom of a toilet tank.

FIGS. 14-17 illustrate an example fluidic oscillator.

FIG. 18 illustrates an example fluidic oscillator layout.

FIG. 19 illustrates another example fluidic oscillator layout.

FIGS. 20-22 illustrate an example fluidic oscillator.

FIG. 23 illustrates another example fluidic oscillator layout.

FIG. 24 illustrates another example fluidic oscillator layout.

FIGS. 25-27 illustrate an example fluidic oscillator.

FIG. 28 illustrates another example fluidic oscillator layout.

FIGS. 29-31 illustrate an example fluidic oscillator.

FIG. 32 illustrates another example fluidic oscillator layout.

FIGS. 33 and 34 illustrate another example fluidic oscillator layout.

FIGS. 35 and 36 illustrate a manifold.

FIGS. 37-40 illustrate an example auxiliary fill valve for the fluidic oscillator.

FIG. 41 illustrates an example controller for any of the disclosed embodiments.

FIG. 42 illustrates a flow chart for a fluidic oscillator water rinsing system.

FIG. 43 illustrates another flow chart for a flush cycle including fluidic oscillator water rinsing system.

### DETAILED DESCRIPTION

The term “plumbing fixture” refers to an apparatus that is connected to a plumbing system of a house, building or another structure. The term “plumbing fixture” may include toilets, faucets, shower heads, bathtubs, urinals. The term “bathroom fixture” and “kitchen fixture” may more specifically refer to individual types of plumbing fixtures found in the bathroom or kitchen, respectively, and these terms may be overlapping in certain examples (e.g., faucets). The following embodiments are described with respect to a toilet but also may be applied to urinals, any type of bathroom fixture, or any type of bathroom fixture. The following fluidic devices are described with respect to a rim of a toilet but may also be applied to a rim of a urinal, an edge of a bathtub, or an edge of a basin.

The plumbing fixture includes one or more fluidics devices or structures that are configured to control the flow of water through one or more jets (e.g., fluid outlets, outlet openings, etc.) of the plumbing fixture. The fluidics devices include interconnected flow channels (e.g., passages, etc.) that include geometries which may be altered to selectively control the flow of water ejected from the fluidics devices. For example, the channels may be configured to provide pulsating or oscillating flows of water to achieve improved water delivery performance through the plumbing fixture, which, advantageously, improves the cleaning capabilities of the plumbing fixture. Alternatively, or in combination, the fluidics devices may be configured to control the timing of the flow through the one or more jets. Multiple fluidic devices may be interconnected through flow channels as well.

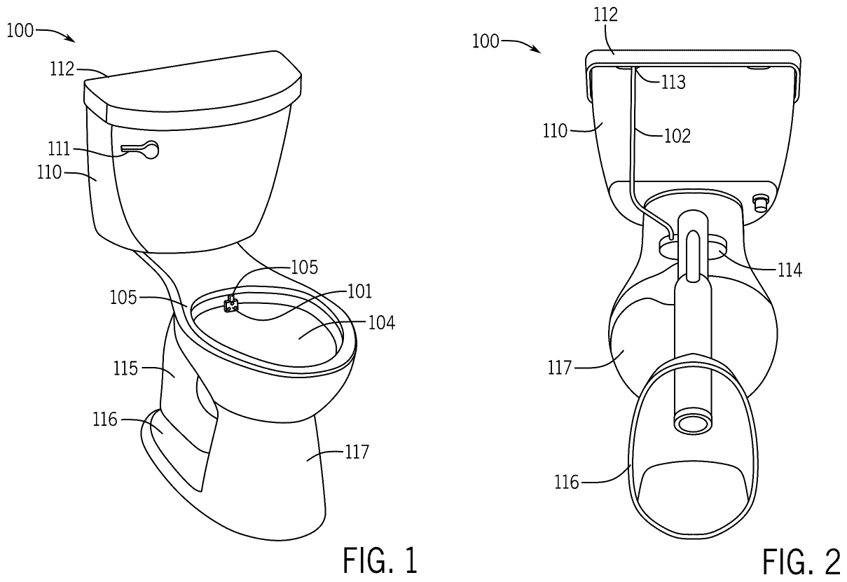

FIGS. 1 and 2 illustrate an example toilet 100, shown as a gravity fed toilet, but other types of toilets such as a line pressure toilet may be used. The gravity fed toilet may include a tank 110 with a lid 112 and a flush lever or handle 111. Pressing or rotating the handle 111 may open a flush valve internal to the tank 110 and release the stored water into the bowl 104 to help evacuate the contents of the bowl through a trapway 115. Alternatively, the following embodiments may be incorporated into a line pressure toilet or a tankless toilet configured to receive water from a water supply conduit, which may include a flushometer. The water supply conduit may be a water supply line inside a household, a commercial property, or another type of building. The water supply conduit may be configured to supply water at a city water pressure or a well pump pressure. The water supply conduit may be a pipe, tube, or other water delivery mechanism extending from a wall of the building. Additional, different, or fewer components may be included.

Any of these types of toilets include a rim 103 defining the upper portion of the bowl 104. At the bottom of the bowl 104 is an opening that leads to the trapway 115.

The toilet bowl 104 includes a surface (e.g., an inner surface, an interior surface, etc.) defining a cavity into which solid or liquid waste may be deposited. The rim 103 may extend inward from an outer edge of the toilet bowl 104. In some embodiments, the toilet 100 is made (e.g., cast or otherwise formed) from a single piece of vitreous material such as clay. The toilet may include one or more openings (e.g., slots, holes, etc.) configured to receive trim, tubing, and/or other components/hardware to facilitate operation of the toilet 100. The toilet 100 may be made (e.g., cast or otherwise formed) from two pieces of vitreous material, which include one piece for the tank 110 and one pieces for the pedestal 117 including a stand 116 or skirt.

An example water rinsing system for the toilet 100 includes a fluidic device 101, a water supply conduit 102, and a bend connector 105. Additional, different, or fewer components may be included.

The fluidic device 101 may include one or more fluidic modules and embodiments herein include two, three, four, five, or any number of fluidic modules interconnected through fluid pathways or through overlapping feedback paths. An example fluidic oscillator may be interchangeably mounted to the toilet. Thus, the toilet may be interchangeably mounted with a range of quantities of fluidic modules (e.g., 2-10 fluidic modules) in a single fluidic device 101. In addition, the toilet may be interchangeably mounted with a range of quantities of fluidic devices 101, each having one or more fluidic modules. A single fluidic device 101 may constitute a fluidic device and thus the term fluidic device 101 may be used to describe one fluidic oscillator in a device having multiple fluidic oscillators. The fluidic device 101 may direct water to the toilet bowl 104.

The water supply conduit 102 may be a tube, a hose, or other fluid directing path. The water supply conduit 102 may connect the fluidic device 101 to a water supply. The water supply may be the water tank 110 of the toilet. The water supply may be the water line (e.g., utility, well) of the building. The water supply conduit 102 supplies water to the fluidic device 101 in proximity to the rim 103 of the toilet bowl 104. The water supply conduit 102 may be fed through or mounted in a cavity formed in the vitreous of the toilet 100. In some example, the cavity formed is the vitreous of the toilet 100 serves as the water supply conduit 102.

The bend connector 105 connects the water supply conduit 102 to the fluidic device 101. The bend connector 105 establishes an angle at which the fluidic device 101 over hangs the rim 103 of the toilet bowl 104. That is, the outlet of the fluidic device 101 is below the top surface of the rim 103 (in the direction of gravity). The outlet of the fluidic device 101 is below the water supply conduit 102. The bend connector 105 may be pointed at a predetermined angle (e.g., with the horizontal) in order to point the fluidic device 101 at the toilet bowl 104.

FIG. 2 illustrates that the water supply conduit 102 passes through a rim channel chamber 114 and then connects to the top opening of the tank 110 through an opening 113. The opening 113 may be a cutout in the body of the tank 110 or another orifice for connecting the water supply conduit 102 to the tank 110.

The rim channel chamber 114 may also include a rim channel that carries water from the tank 110 to the rim 103 for flushing the toilet. In other examples described herein the water supply conduit 102 connects to the bottom of the tank 110 or directly to a water supply plumbing fixture.

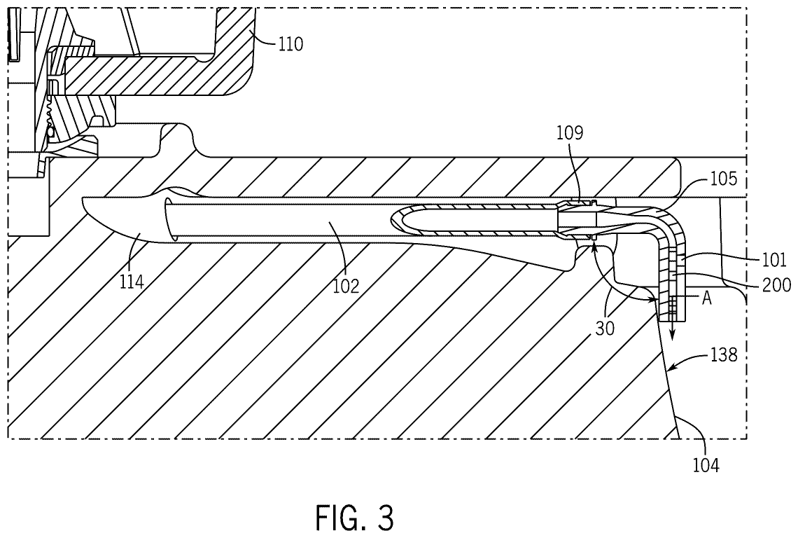

FIG. 3 illustrates a more detailed view of the fluidic oscillator device 101 of FIGS. 1 and 2. The bend connector 105 connects the water supply conduit 102 to the fluidic device 101 at junction device 109. The bend connector 105 may include a male portion of the junction device 109 and the water supply conduit 102 includes a female portion of the junction device 109. The junction device 109 may include a snap-fit connector, a push connector, or screw vanes to connect the water supply conduit 102 and the bend connector 105.

The bend connector 105 and the fluidic device 101 may be formed integrally out of a single material as a single device. Alternatively, the bend connector 105 and the fluidic device 101 are separate components.

The fluidic device 101 is connected to a water supply in the tank 110. The water supply conduit 102 is connected to the rim channel chamber 114 to pass through the toilet body to the back of the toilet where it is connected to the tank 110. Additional, different, or fewer components may be included.

The fluidic device 101 may direct water to the toilet bowl 104 in a direction A and at a predetermined region 138. The direction A may point substantially in the direction of gravity. That is, the bend connector 105 may turn the flow of water by 90 degrees from substantially horizontal to substantially vertical. In another example, the bend connector 105 may turn the flow of water by another angle such as 20 degrees to 70 degrees. The bend connector may be rigid and formed integrally with the fluidic device 101 and/or of the same material as the fluidic device 101.

Alternatively, the bend connector 105 may be adjustable to various angles (e.g., measure from the water supply conduit 102 is angle 30). For example, the bend connector 105 may be formed with a flexible material such as corrugated or ridged plastic that can be bent in various configurations and still hold the shape. The bend connector 105 may be formed from metal (e.g., galvanized iron wire) wrapped and compressed into spaces of a spring coil (stainless steel or brass can also be used). The friction between the metal and the spring may provide the bend connector 105 with the ability to hold a position after it is bent. The angle 30 may be adjusted to different bowl shapes, water height, user preference, or based on cleaning results. The angle 30 may be selected based on a tilt angle that the bowl 104 is mounted (e.g., with respect to a floor surface).

The predetermined region 138 is a span of the toilet bowl 104 that corresponds to the direction A for the fluidic device 101. The predetermined region may be a portion of the slanted surface of the toilet bowl 104. The predetermined region 138 may be the portion of the bowl 104 that is below the outlet of the fluidic device 101 (e.g., a portion of the bowl 104 may be above the outlet of the fluidic device 101). The predetermined region 138 may depend on angle 30.

As the orientation of the fluidic device 101 indicates, the internal components are also in the direction A. The fluidic device 101 includes at least one passive passage 200 with a flow direction that is substantially vertical or at the angle to overhang the rim 103 of the toilet bowl 104.

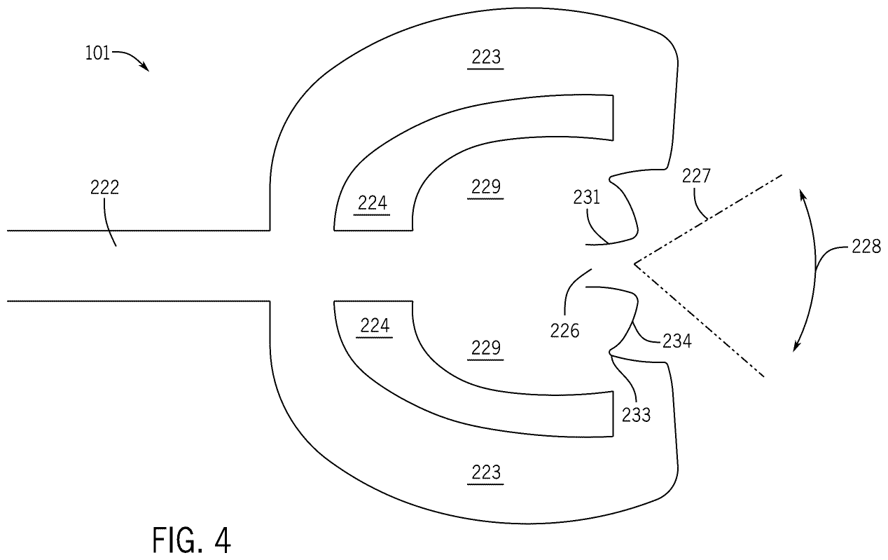

FIG. 4 illustrates an example of a fluidic device 101 including multiple examples of the passive passage. The passive passage may include a diffuser, a feedback channel, an amplifier, or a diverter. Illustrated is an internal cross section of the fluid oscillator 101 at a position between a top (inlet) and a bottom (outlet) of the fluid oscillator 101. The fluid oscillator 101 includes a main flow channel 222, one or more feedback channels 223, an island 224, a mixing chamber 225, an outlet 226 and one or more geometric features at the outlet of the fluid oscillator 101 that cause a fan output water flow 227 to oscillate, fluctuate, or pulsate across a predetermined angle range 228. The repeating pattern of water includes a back and forth pattern about the vertical direction or in parallel to the slop of the toilet bowl 104. The main flow channel 222 may include a narrowing passage that acts as an amplifier for the velocity of the flow of water. For example, the positions of the islands 224 may be adjusted to create such a narrowing passage and amplifier. Additional, fewer, or different components may be used.

The fluid oscillator 101 includes a main flow channel 222 at least partially in parallel to one or more feedback channels 223. As shown in FIG. 4, each of the feedback channels 223 is substantially parallel in part to the main flow channel 222 and each of the feedback channels 223 provides a path in the opposite direction (upstream) of the main flow channel 222 (downstream).

The fluid oscillator 101 includes at least one island divider 224 configured to separate the mixing chamber 225 from each feedback channel 223. The divider 224 my partially or fully extend from the bottom to the top of the fluidic oscillator 101.

The fluid oscillator 101 includes a mixing chamber 225 in communication with the main flow channel 222 and each of the feedback channels 223. The main flow channel 222 includes a pressurized fluid to create a spatially oscillating (fan sweep back and forth) jet. No power source is required. However, the input fluid (e.g., water supply) is provided under pressure or under with potential energy from gravity. The diameter of the pipe may be selected to increase or decrease the input fluid to a desired pressure. The curved walls of the mixing chamber 225 provide a path for the flow of fluid to exhibit the coanda effect in which the flow attaches itself to the walls of the mixing chamber 225 and changes direction because it remains attached as the curved walls of the mixing chamber 225 curve away from the initial direction from the main flow channel 222. In addition or in the alternative, the mixing chamber 225 provides one or more pockets 229 for a separation flow to form that is triggered from the output from the respective feedback channel 223. The separation flow pushes the main flow away from the walls of the mixing chamber 225 to cause the oscillation to be realized in the output of the fluid oscillator 101.

The fluid oscillator 101 includes one or more geometric features at the outlet of the fluid oscillator 101 that cause a fan output water flow 227 to oscillate across a predetermined angle range 228. The fluidic oscillator 101 is self-sustaining and self-inducing by virtue of the shape of the main flow channel 222, the feedback channels 223, the island 224, and/or the mixing chamber 225.

In addition, one or more features of the outlet of the fluidic oscillator 101 applies a limiting condition (diffuser) on the fan output water flow 227 to oscillate across the predetermined angle range 228. The limiting condition may be a geometric feature of the outlet of the fluidic device 101. In one example, the limiting condition is provided by a geometry including a narrow neck 231 extended into the mixing chamber 225. The neck 231 limits the predetermined angle range 228 by blocking some of the flow of water that unimpeded would have escaped the mixing chamber 225 to the outlet of the fluidic oscillator 101. The narrow neck 231 may also set a particular oscillation frequency due to reflection of the fluid back into the fluidic oscillator 101. The neck 231 may be omitted to reveal a larger outlet of the fluidic device 101.

In one example, the limiting condition is provided by a geometry including a convex portion 233 that adjusts a path of the output of the feedback path 223. The convex portion 233 may direct the feedback flow of fluid into the pocket 229 at a smaller angle thus increasing the separation flow and, accordingly, the frequency of the output of the fluidic oscillator 101.

In one example, the limiting condition is provided by a geometry including a concave portion 234 configured to reverse the flow outside of the neck 231 internally into the mixing chamber 225. Fluid that otherwise would have flowed to the outlet of the fluidic oscillator 101 flows into the concave portion 234 then back into the rotational flow of the mixing chamber 225 as an additional feedback input to the mixing chamber 225. Thus, the concave portion 234 may be referred to as an auxiliary feedback for the fluidic oscillator 101.

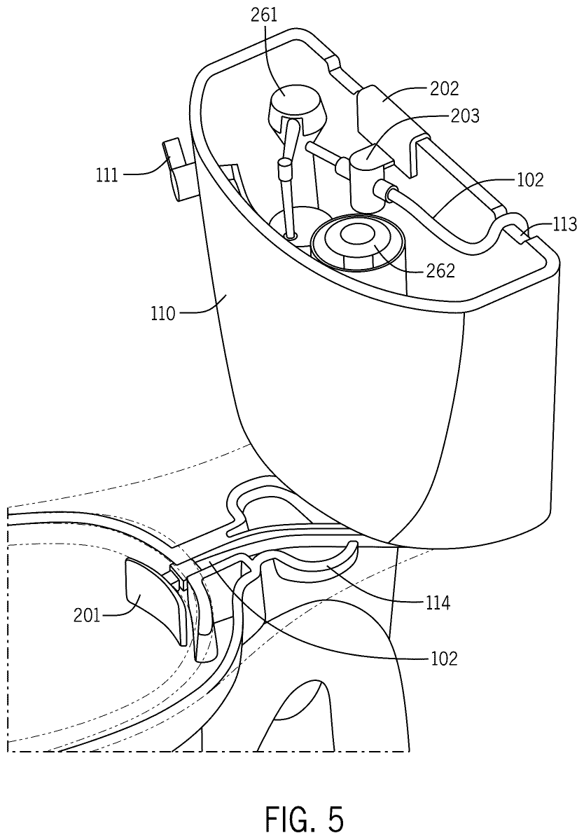

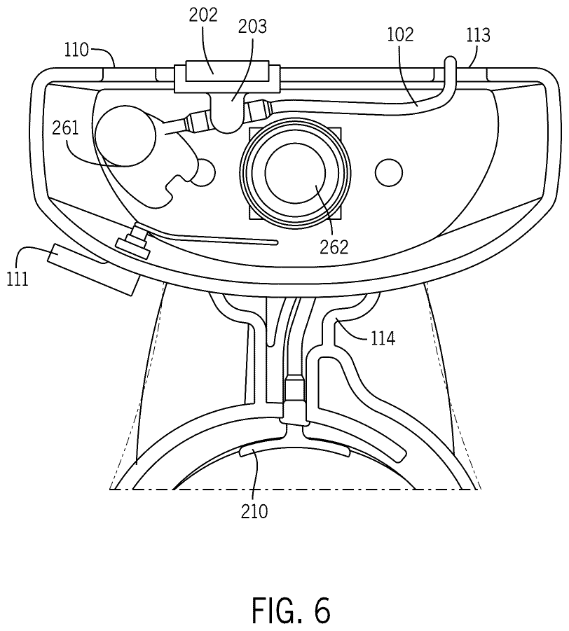

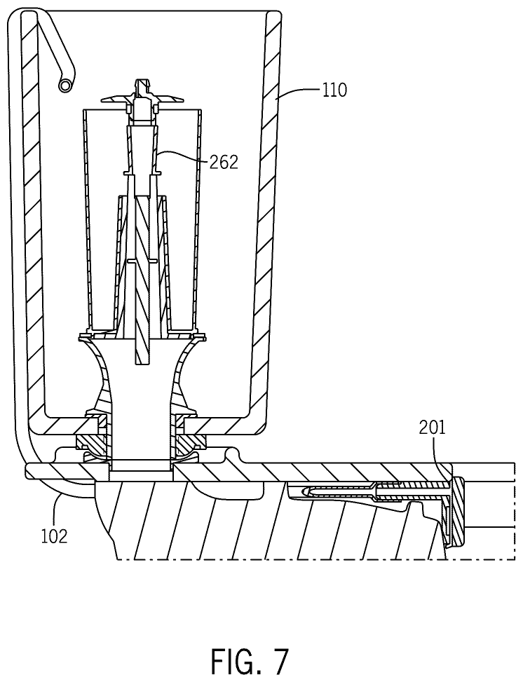

FIGS. 5, 6 and 7 illustrate another embodiment of a fluidic oscillator 201. The fluidic oscillator 201 includes a curved housing and/or at least one passive passage that is curved with this curved housing. The curve of the fluidic oscillator 201 may be parallel or substantially parallel to the curve of the rim 103 of the toilet 100. The term substantially parallel may mean a deviation from parallel within a predetermined distance, angle, or radius of curvature. The fluidic oscillator 101 may have a curved housing with a radius of curvature within a predetermined range of that the rim 103 of the toilet 100.

FIG. 5 also illustrates a support 202 for the water supply conduit 102. The support 202 may include a hook or U-shape that allows the support to hang on the water tank 110. The support 202 alternatively may be mounted to the side of the tank using a bolt, screw, adhesive or another fastener. The support 202 may include a magnet or magnetic component which is secured to the tank 110 with another magnet or magnetic component outside of the tank.

The support 202 may be coupled with an oscillator valve 203. The oscillator valve 203 is configured to supply water to the water supply. Details of the oscillator valve 203 are described in further embodiments. The valve oscillator 203 may be responsive to a flush cycle of the toilet 100 (i.e. the valve actuates at certain times in response to operation of the toilet 100). The oscillator valve 203 may operate according to a float in the tank 110. The oscillator valve 203 may be controlled electronically or manually.

A flush cycle may be implemented using a fill valve 261 and a flush valve 262 (e.g., a cannister including flush valve 262). The flush valve 262 is actuated based on lever 111 or another actuator (e.g., via chain 263 or another type of cord or cable). The fill valve 261 supplies water to refill the tank 110 and/or provide water to rim of the toilet 100. The water supply conduit 102 may also receive water from the fill valve 261 and supply the water to the fluidic device 101.

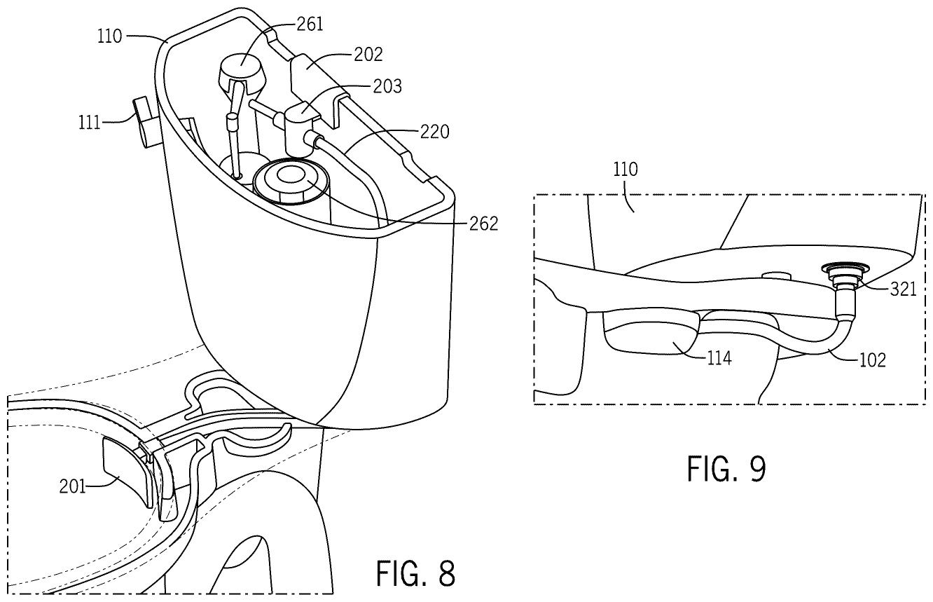

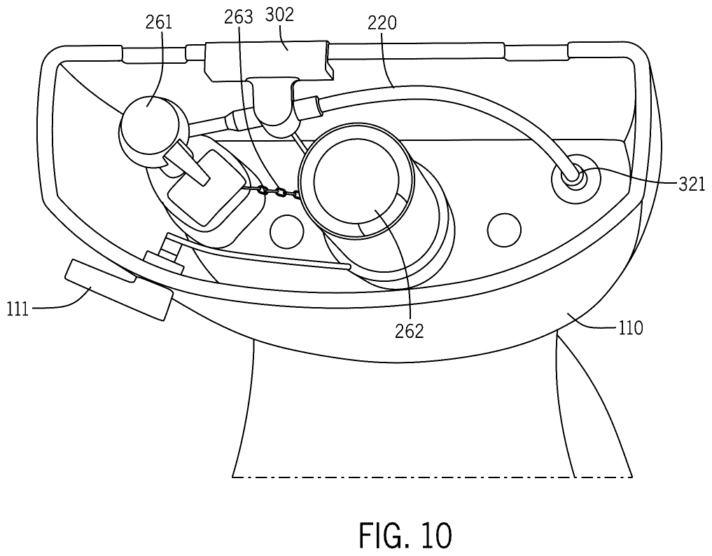

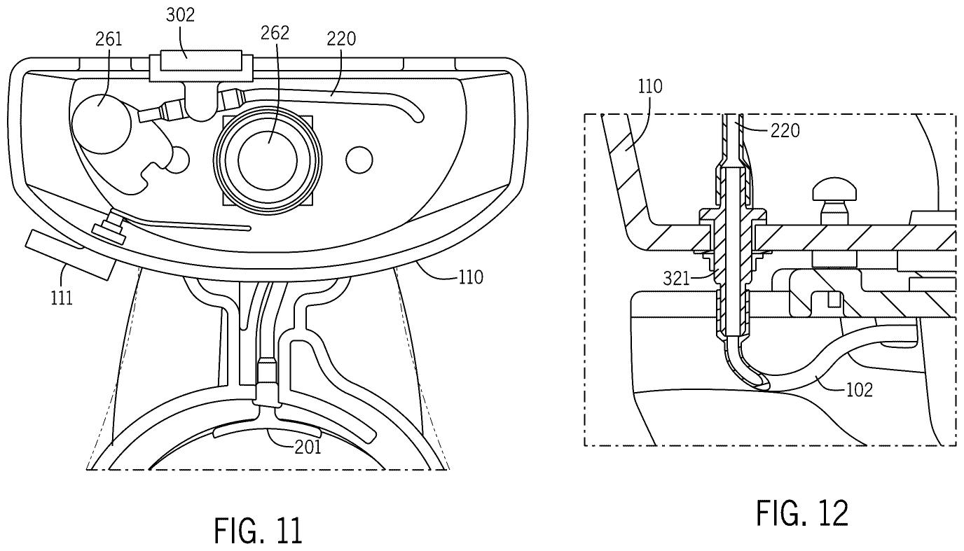

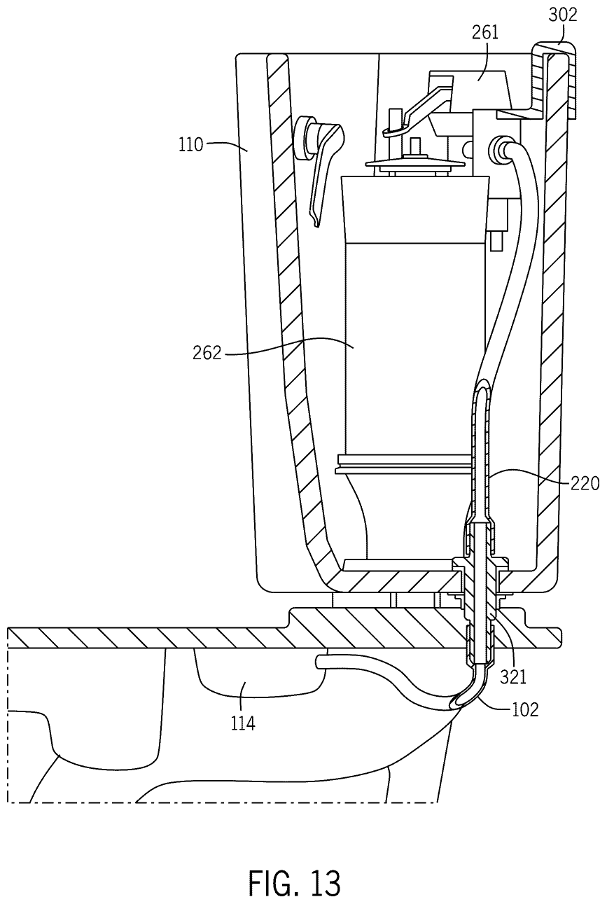

FIGS. 8, 9, 10, 11, 12, and 13 illustrate another embodiment of a fluidic oscillator installation. As in prior embodiments the fluidic oscillator 201 is curved to match the contours of the rim 103 of the toilet 100 and is connected using the bend connector 105 or otherwise is pointed towards the bowl 104 using an internal channel of the fluidic oscillator 201. Additional, different, or fewer components may be included.

In addition, in this fluidic oscillator installation, the water source for the water supply conduit 102 is the tank 110 and the water supply conduit 102 is connected directly to the bottom of the tank using a lock nut 321. The lock nut 321 may be made of plastic or another material. The lock nut 321 provides a water path from the inside of the tank 110 to the water supply conduit 102. The lock nut 321 and fill valve 261 are illustrated on opposite sides of the tank 110. However, the lock nut 321 and fill valve 261 may be on the same side.

Also, rather than the bottom of the tank, the lock nut 321 may connect the water supply conduit 102 on a side of the tank 110. The height where the lock nut 321 connects the water supply conduit 102 to the side of the tank 110 may be selected so that the fluidic device 101 is operated at a certain portion of the flush cycle. In addition, valve or diverted may be included with a side mounted lock nut 321.

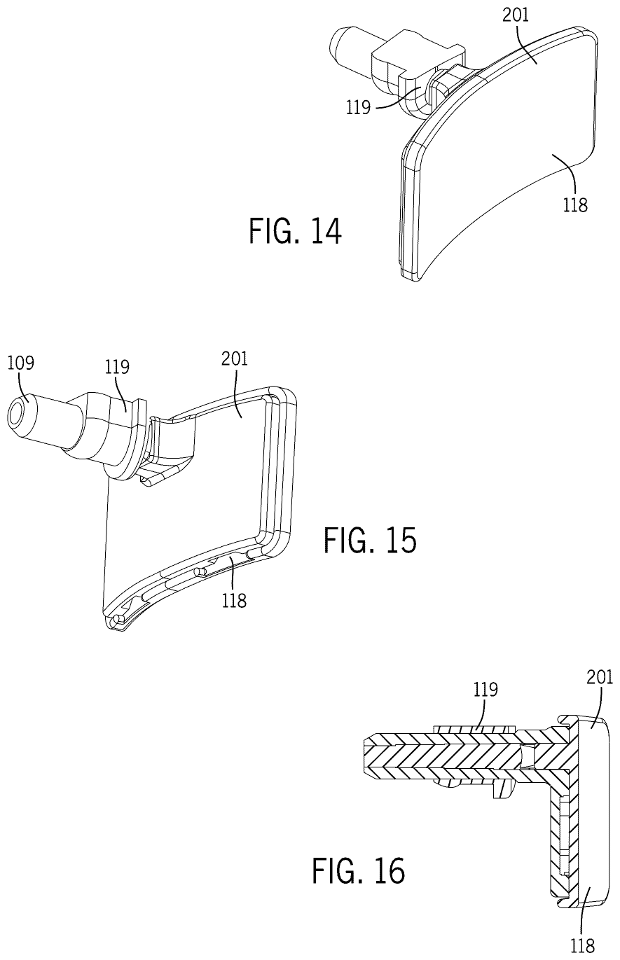

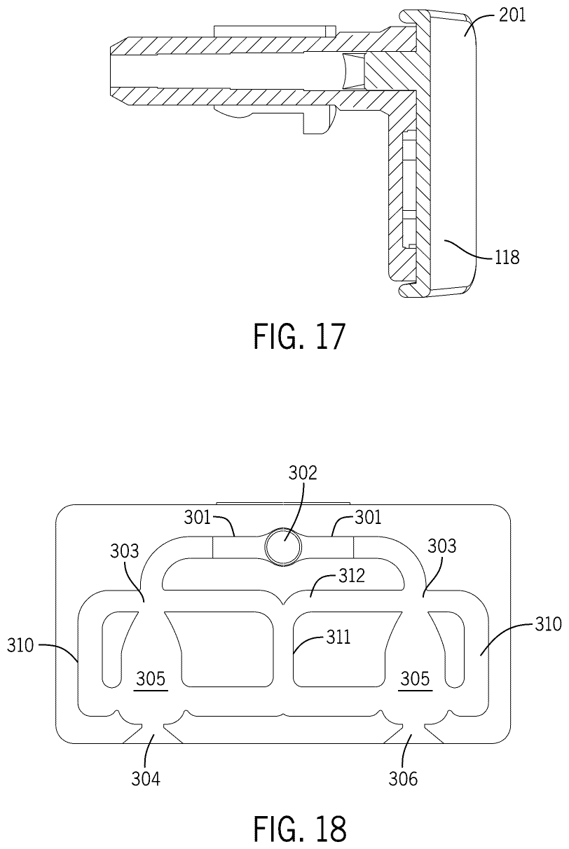

FIGS. 14-17 illustrate an example fluidic oscillator 201. The fluidic oscillator 201 includes a plurality of passive chambers through which water flows under the force of gravity and/or the line pressure of the plumbing system.

The fluidic oscillator 201 includes a cap or cover 118 that is placed over the fluidic oscillator 201. The fluidic oscillator 201 chambers and hardware, as shown in FIG. 4, for example, may be observable from the outside of the fluidic oscillator 201. The cover 118 is placed over the fluidic oscillator 201 to select an appearance. In some examples, the cover 118 may be selected to match the color or other aesthetic of the bowl 110 or rim. In this way, the fluidic oscillator 201 blends in with the toilet 100. In other examples, the features, or presence, of the fluidic oscillator 201 may be highlighted by the cover 118. For example, a metallic, chrome, or nickel finish may accentuate the fluidic oscillator 201.

The fluidic oscillator 201 may include the junction device 109, as described above, to connect to one or more supply hoses, T connectors, or manifolds. A separate connector, flexible mount 119 may connect the fluidic oscillator 201 to the toilet 100 by press fit into a cavity in the toilet 100.

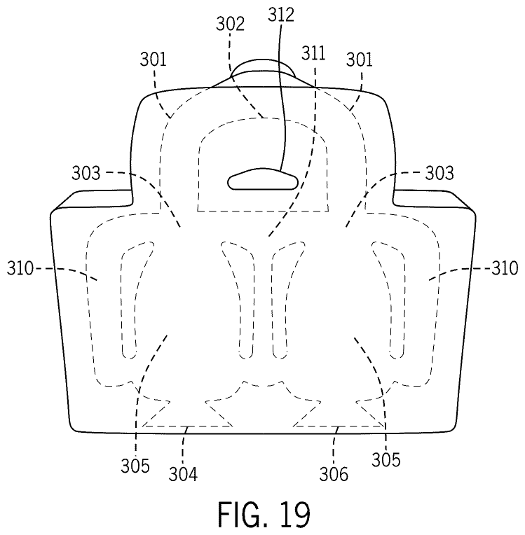

FIG. 18 illustrates an example fluidic oscillator layout. FIG. 19 illustrates another example fluidic oscillator layout. The fluidic oscillator 201 may include an inlet 302, one or more angled passages 301 (e.g., corresponding to the bent connector 105), one or more junction chambers 303, one or more mixing chambers 305, one or more feedback channels 310, and one or more dual feedback channels 311 spaced apart from the mixing chambers 305. Each mixing chamber 305, and optionally including adjacent passages or channels adjacent to the mixing chamber 305, may be considered a fluidic module. Thus, the example of FIG. 18 may be considered a fluidic oscillator having two fluidic modules.

The fluidic oscillator may be configured to switch the flow between two different flow channels (e.g., a bi-stable fluidic oscillator) or a direction of the flow (e.g., a mono-stable fluidic oscillator), and a flow restrictor configured control timing of flow delivery to one or more channels or openings. The fluidic oscillator uses the coanda effect (e.g., the tendency of a fluid to remain attached to a curved or convex surface) to facilitate flow switching between the outlets. Among other benefits, the geometry of the channels in the fluidic oscillator allows timing and switching functions to be performed without moving parts and without a power source.

Water provided by the water supply conduit 102 travels through the inlet 302 and the angled passages 301 into the mixing chambers 305. The water is accelerated in the mixing chamber by way of the feedback channels 310. In addition, since each of the mixing chambers feeds into the dual feedback channels 311, the outflow of water from the outlets 304 and 306 are dependent on each other. The feedback channel 311 then connects multiple mixing chambers.

The dual feedback channel 311 causes the oscillation between water flowing out of the outlets 304 and 306. The lateral spacing channels 312 control the frequency (duty cycle, or time period) of the oscillations and/or the relative volume of water (e.g., ratio) between the outlets 304 and 306. The dual feedback channel 311 may be closer to one of the fluidic modules or mixing chambers in order to provide a higher flow rate or stronger spray out of one of the outlets 304 and 306. The lateral spacing channels 312 are omitted or have a short length in the example of FIG. 19. Because the feedback channel 311 is connected to multiple mixing chambers, the output between the outlets 304 and 306 may become synchronized and change direction at the same time, which may be sweeping left and right in paired unison (e.g., in a pattern similar to windshield wipers).

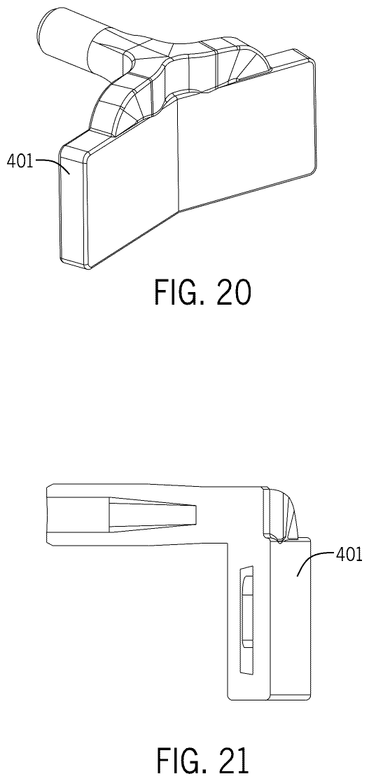

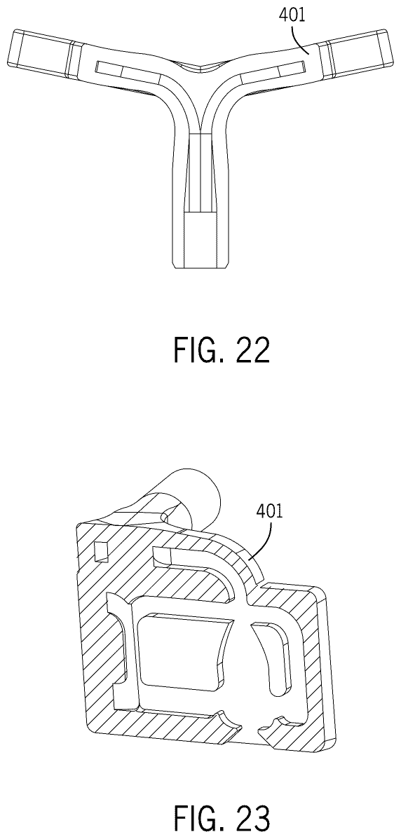

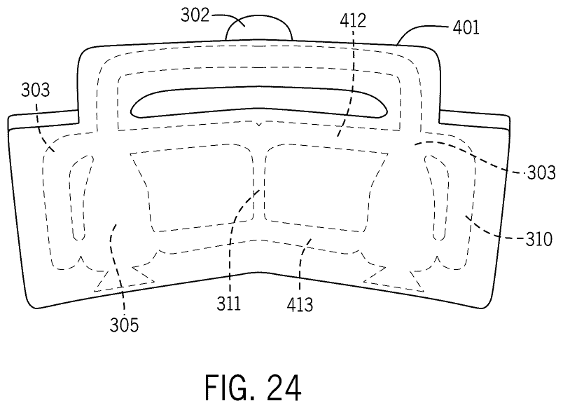

FIGS. 20-22 illustrate an example fluidic oscillator 401 having two oscillator modules. FIG. 23 illustrates another example fluidic oscillator layout. FIG. 24 illustrates another example fluidic oscillator layout. In these examples, rather than curved (e.g., fluidic oscillator 201), the fluidic oscillator is segmented, having two or more planes that meet at an angle. The angle may be selected to approximate the radius of curvature of the rim 103 of the toilet 100.

The fluidic oscillator 401 may include an inlet 302, one or more angled passages (e.g., corresponding to the bent connector 105), one or more junction chambers 303, one or more mixing chambers 305, one or more feedback channels 310, and one or more dual feedback channels 311 spaced apart from the mixing chambers 305. Each mixing chamber 305, and optionally including adjacent passages or channels adjacent to the mixing chamber 305, may be considered a fluidic module. Thus, the example of FIG. 24 may be considered a fluidic oscillator having two fluidic modules. In addition, transverse passages including an upper traverse passage 412 and a lower traverse passage 413 may space the one or more mixing chambers 305 from the dual feedback channel 311. The length of the traverse passages may be greater than in other embodiments. For example, a length of the upper traverse passage 412 and the lower traverse passage 413 may be wider than the width of the mixing chamber 305. In addition or alternatively, a distance between the feedback chamber 311 and the mixing chamber 305 may be wider than the width of the mixing chamber 305.

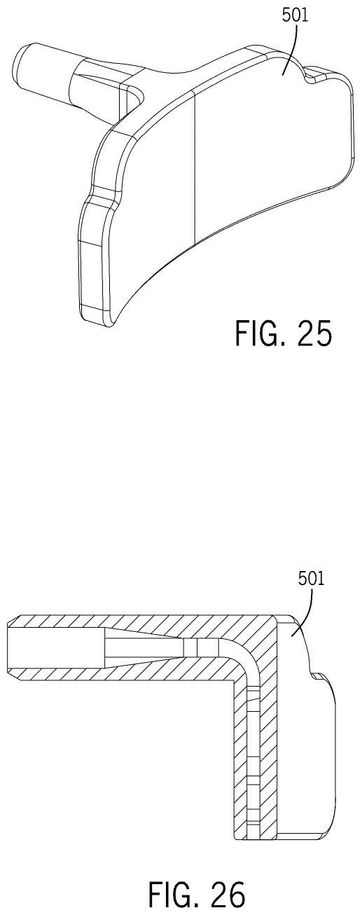

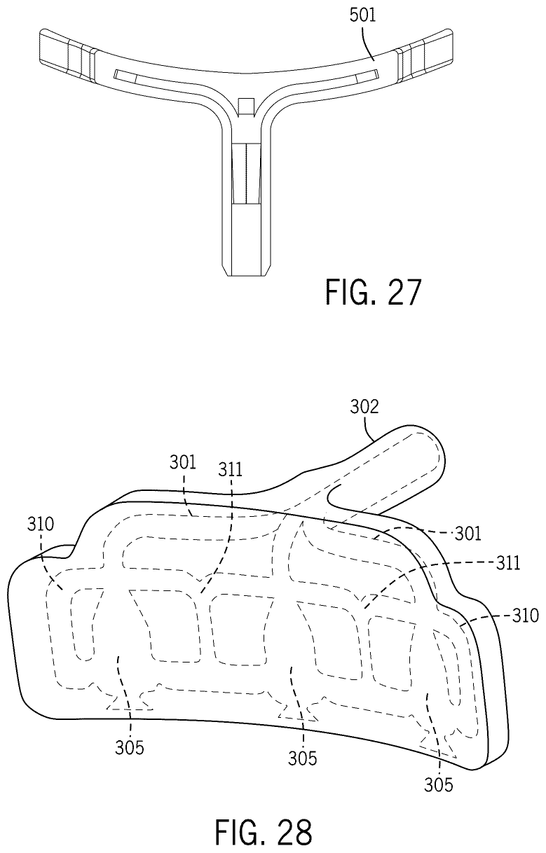

FIGS. 25-28 illustrate an example fluidic oscillator 501 having three oscillator modules. FIG. 28 illustrates another example curved fluidic oscillator layout including three mixing chambers 305, three outlets, two feedback channels 310, and two dual feedback channels 311.

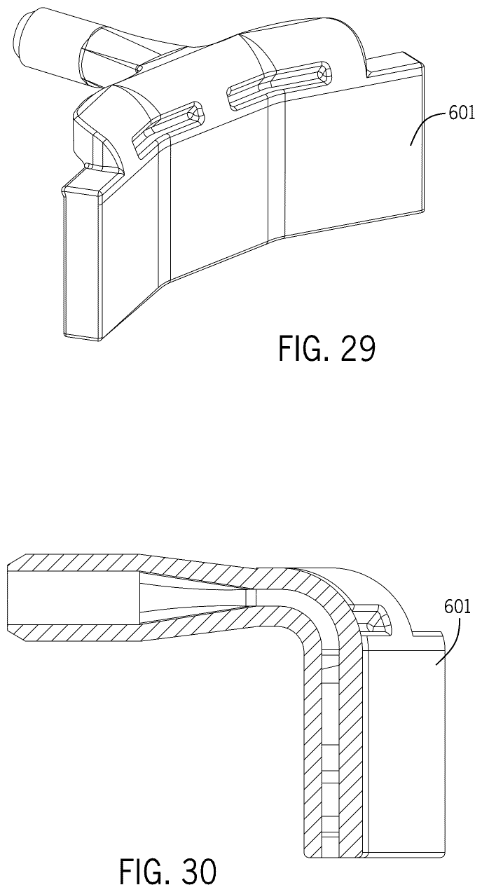

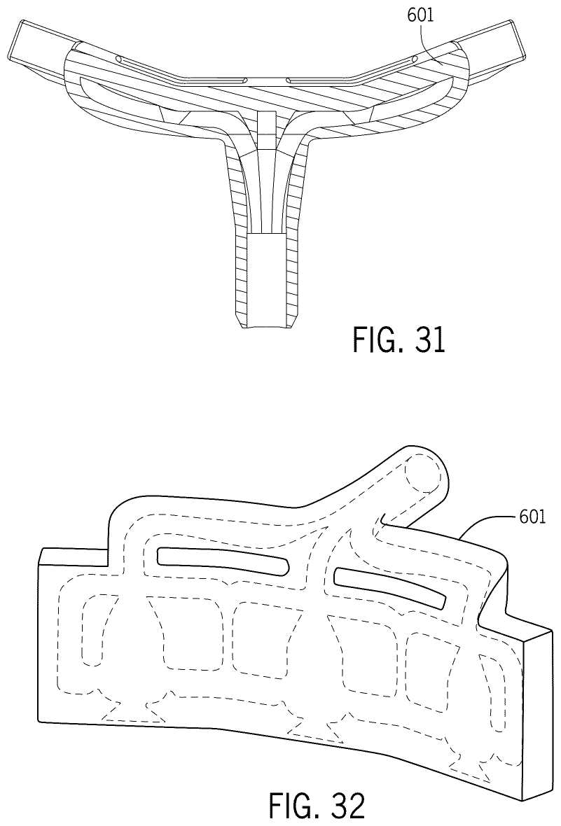

FIGS. 29-31 illustrate an example segmented fluidic oscillator 601 having three oscillator modules. FIG. 32 illustrates another example fluidic oscillator layout. Having three fluidic modules, the example segmented fluidic oscillator 601 includes three segments. The angles between the segments may be different or the same. The angles between the segments may selected according to the radius of curvature of the rim 103 of the toilet 100.

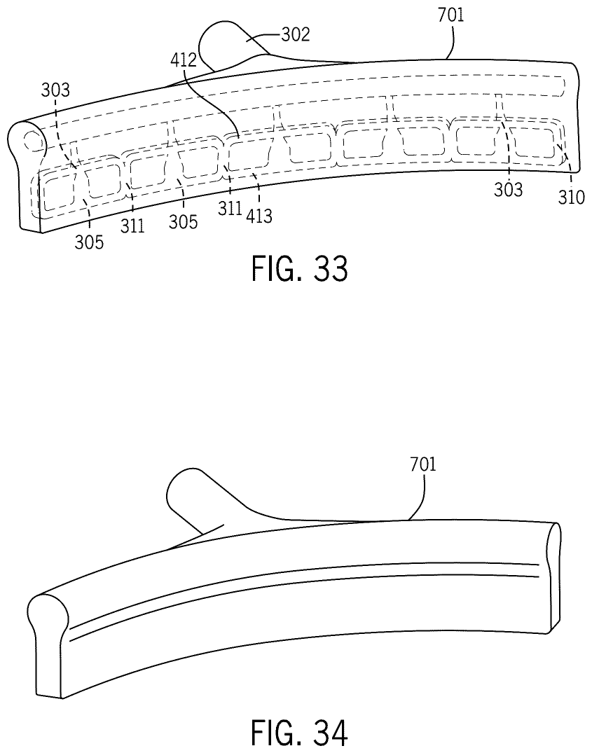

FIGS. 33 and 34 illustrate an example fluidic oscillator device 701 having five oscillator modules. The fluidic oscillator 701 may include an inlet 302 that splits into five channels or connectors for the five oscillator modules. The fluidic oscillator 701 may include one or more angled passages (e.g., corresponding to the bent connector 105), one or more junction chambers 303, one or more mixing chambers 305, one or more feedback channels 310, one or more traverse channels 412 and 413, and one or more dual feedback channels 311 spaced apart from the mixing chambers 305. Each mixing chamber 305, and optionally including adjacent passages or channels adjacent to the mixing chamber 305, may be considered a fluidic module.

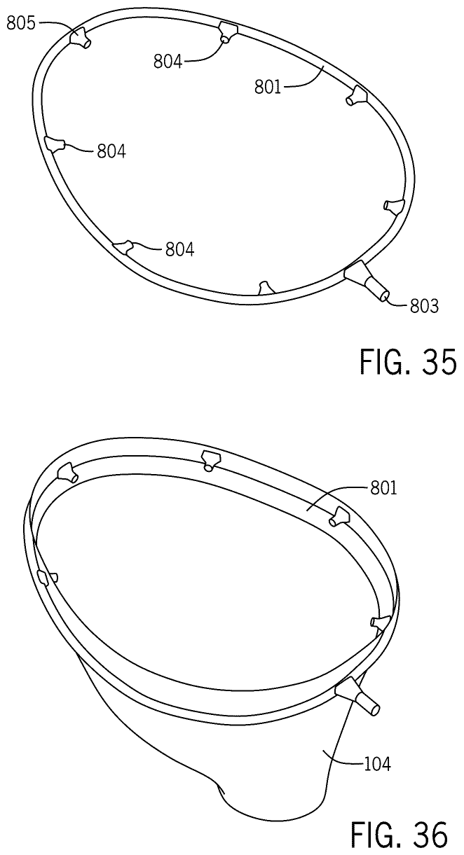

FIGS. 35 and 36 illustrate a manifold 801 to connect fluidic oscillator devices to bowl 104. The manifold 801 includes a water channel with connector 803. The connector 803 is configured to couple to the water supply conduit 102. The manifold 801 provides a passage of water around the circumference of the bowl 104. The manifold 801 may be mounted at the rim, below the rim, above the rim, or another location. The manifold includes multiple output ports 804 spaced around the circumference of the bowl 104.

In some examples, the manifold is circular or oval and completes the entire circumference of the bowl. In other examples, the manifold is U-shaped so that each leg provides water to a portion of the bowl. The front port 804 may be omitted in the U-shaped embodiment. In the example, of FIG. 35, the manifold 801 provides water along the entire circumference. A fluidic oscillator device 101 is mounted to each of the front ports. In the example of FIG. 35 seven fluidic oscillators 101 are arranged around the circumference of the bowl.

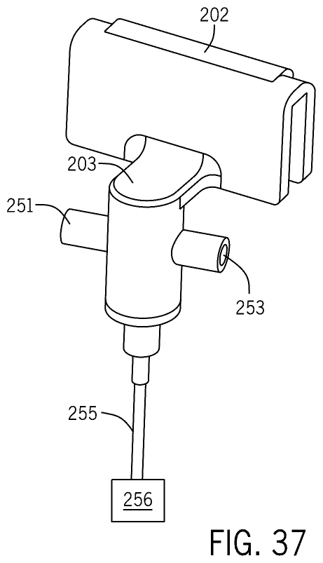

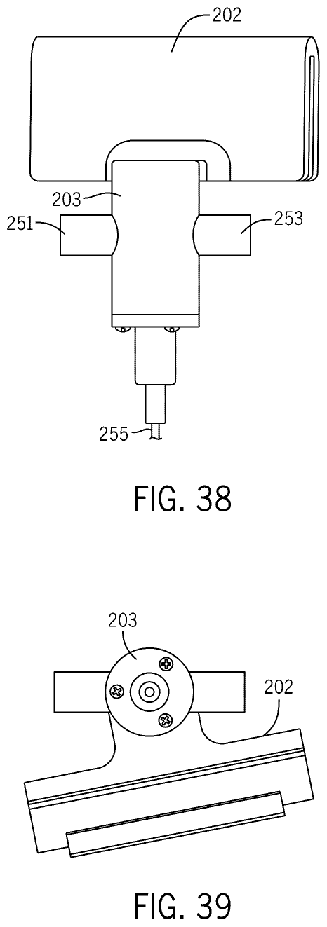

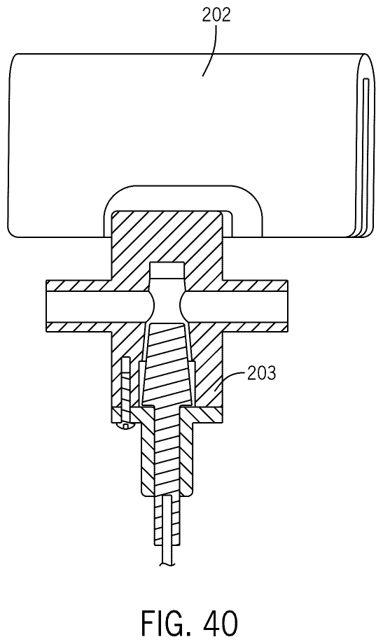

FIGS. 37-340 illustrate an example auxiliary fill valve 203 for the fluidic oscillator. The fill valve 203 may include an inlet 251 and an outlet 253 that are selectively connected or opened by a valve member internal to the fill valve 203.

The valve member may open and close the passage between the inlet 251 and the outlet 253 in response to a flush cycle. One implementation may include a float 256 connected by a rod 255. When the tank is full (or above a predetermined level) the float 256 place an upward force on the rod 255, which is connected to the valve member. The upward force on the rod 255 causes the valve to be closed and prevent water flow between the inlet 251 and the outlet 253. When the toilet 100 is flushed, the water empties the tank and the rod 255 no longer places an upward forced on the valve member (or places a downward force on the valve member due to gravity at the weight of the rod 255 and/or float 256). Thus, went the tank is emptied as part of the flush cycle, the valve 203 is opened and water flows into the fluidic oscillator.

The valve 203 may also be controlled mainly through a level inside or outside of the tank 110. That is, the user may mechanically open the valve 203 so that the fluidic oscillator sprays the sides of the bowl.

In another example, the valve 203 may be controlled electronically, as described below.

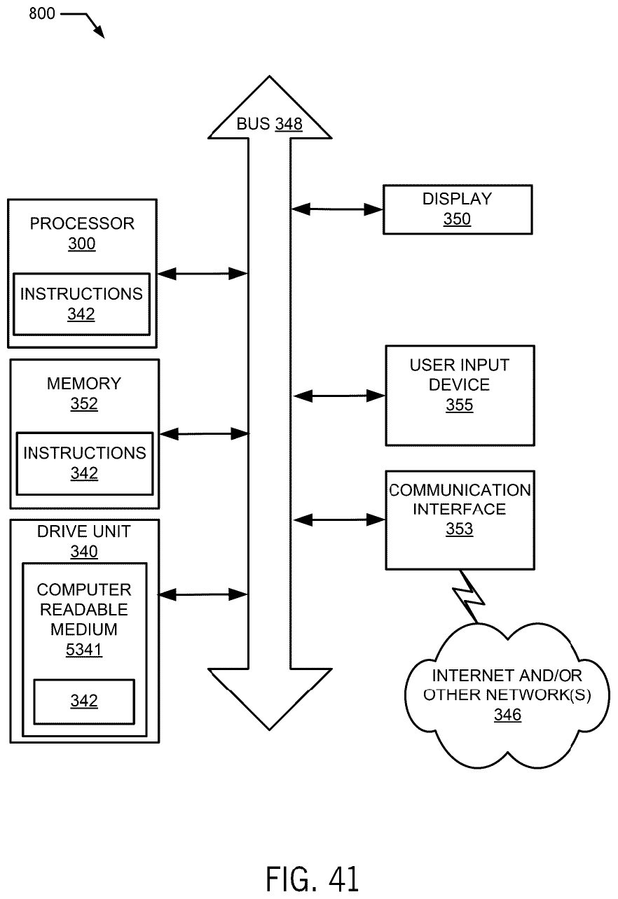

FIG. 41 illustrates an example controller 800 for any of the disclosed embodiments. The controller 800 may include a processor 300, a memory 352, and a communication interface 353 for interfacing with devices or to the internet and/or other networks 346. In addition to the communication interface 353, a sensor interface may be configured to receive data from the sensors described herein or data from any source. The components of the control system may communicate using bus 348. The control system may be connected to a workstation or another external device (e.g., control panel) and/or a database for receiving user inputs, system characteristics, and any of the values described herein.

The processor 300 may receive input data and initiate operation of the valve 203 in response to the input data. The valve 203 may be actuated by a solenoid or motor. The processor 300 may generate a valve command in order to operate the solenoid or the motor to open or close the valve 203.

The input data may be indicative of a flush cycle. In one example, the processor 300 may control the flush cycle (e.g., operation of a flush valve). The input data may be received from a user input. For example, the flush lever may be electronically or wirelessly connected to the processor 300. In response to turning the flush lever (or a predetermined time thereafter), the processor generates the valve command so that water is dispensed from the fluidic oscillators and the appropriate time in the flush cycle.

The input data may be received from a dedicated button, switch, keypad, or other input device through which the user directly instructs the processor 300 to turn on the fluidic oscillators. The input data may be received wirelessly from a remote control, a smartphone, a tablet or another mobile device.

The input data may be received from a sensor interface. The sensor interface may detect the presence of the user such as by a proximity sensor or a weight sensor. The sensor interface may detect a gesture made by the user. The sensor may detect waste in the bowl or on the side of the bowl that requires cleaning from the fluidic oscillators.

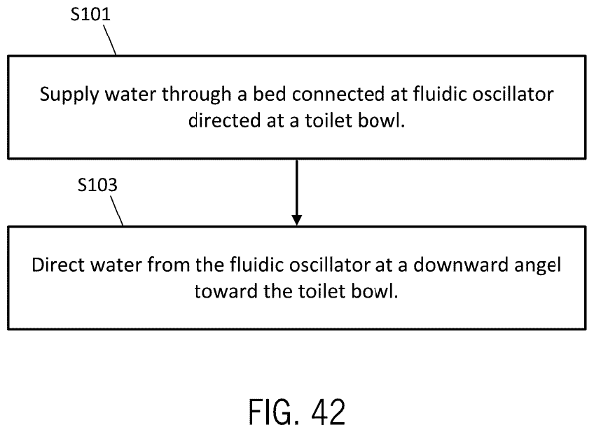

FIG. 42 illustrates a flow chart for a fluidic oscillator water rinsing system. Additional, different, or fewer acts may be included.

At act S101, water is supplied through a bend connector to a fluidic module at a rim of the toilet bowl. The supply of water may be controlled via a valve or solenoid, which is actuator according to a signal or command from the controller 800. The actuation may be part of a flush cycle or as a result, a direct input from the user, or other sensor data for the ambient environment or condition of the bowl.

At act S103, an oscillating flow of water is directed from the fluidic module at a substantially downward angle at the toilet bowl. The downward angle may cause the water to spray in the direction of gravity or substantially the direction of gravity. The downward angle may be at an acute angle with the surface of the sides of the bowl.

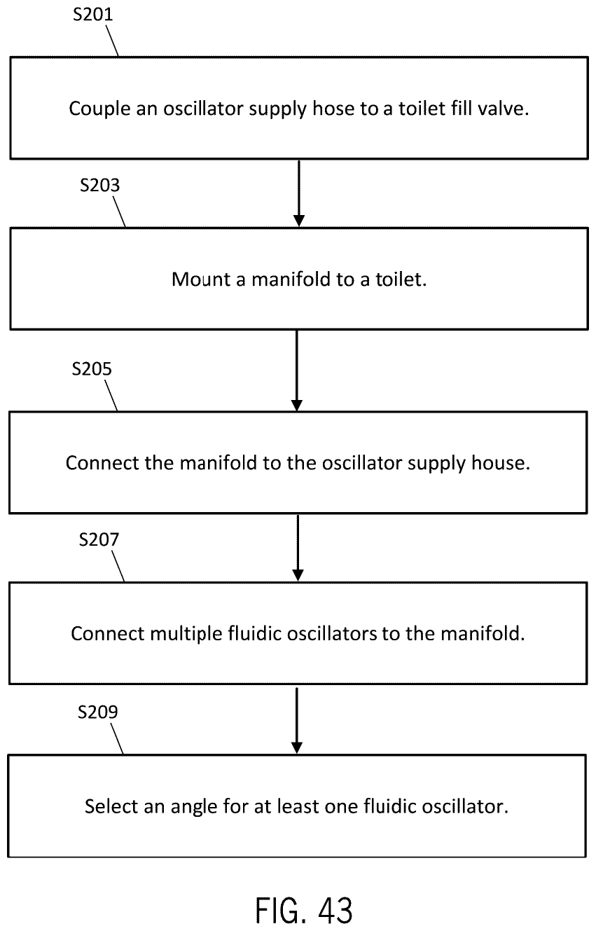

FIG. 43 illustrates a flow chart for a manufacturing process for the fluidic oscillator water rinsing system. Each of these acts may be performed by a technician or by one or more machines (e.g., robot). Additional, different, or fewer acts may be included.

At act S201, an oscillator is connected by supply hose to a fill valve. The supply hose (e.g., water supply conduit 102) may include at least a portion that pass through a toilet tank. The supply hose may include at least a portion that passes through a vitreous cavity of a pedestal of the toilet. The supply hose may include at least a portion that passes between the toilet tank and the pedestal. The supply hose may include at least a portion that passes through a connector in the toilet tank.

At act S203, a manifold is mounted to a toilet (e.g., toilet rim). The manifold may be mounted under the rim of the toilet. The manifold may be mounted inside a cavity in the vitreous after the toilet is formed. The manifold may be placed inside a mold for forming the toilet and mounted to the toilet as the vitreous is formed. The manifold connects to the supply hose either directly or indirectly. The manifold includes multiple output ports along one or more water passages.

At act S205, the manifold is connected to the supply hose. A fastener may be used to connect the supply hose and the manifold. At act S207, a plurality of fluidic oscillators are connected to the manifold. The fluidic oscillators may press or snap onto the manifold by aligning the output ports of the manifold to the input ports of the fluidic oscillators.

At act S209, select an angle of at least one of the fluidic oscillators. The angle may be selected by rotating the output port of the manifold. The angle may be selected by bending the supply tube (e.g., bend connectors) for the fluidic oscillators. The fluidic oscillator may include a pivoting member that allows the angle of the oscillator to be adjusted through manual include. In another example, a motor is used to rotate the fluidic oscillator through a signal or command from the controller 800.

Optionally, the control system may include an input device 355 and/or a sensing circuit 356 in communication with any of the sensors. The sensing circuit receives sensor measurements from sensors as described above. The input device may include any of the user inputs such as buttons, touchscreen, a keyboard, a microphone for voice inputs, a camera for gesture inputs, and/or another mechanism.

Optionally, the control system may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be an indicator or other screen output device. The display 350 may be combined with the user input device 355.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, the memory 352 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A water rinsing system for a toilet, the water rinsing system comprising:
a fluidic module configured to direct water to a toilet bowl;
a water supply configured to supply water to the fluidic module at a rim of the toilet bowl from a water source; and
a bend connector configured to connect the fluidic module and the water supply at an angle to overhang the rim of the toilet bowl.

2. The water rinsing system of claim 1, wherein the fluidic module includes at least one passive passage with a flow direction that is substantially vertical or at the angle to overhang the rim of the toilet bowl.

3. The water rinsing system of claim 2, wherein the at least one passive passage includes a diffuser, a feedback channel, an amplifier, or a diverter.

4. The water rinsing system of claim 2, wherein the at least one passive passage includes at least one mixing chamber.

5. The water rinsing system of claim 2, wherein the at least one mixing chamber is a plurality of mixing chambers connected by a feedback channel.

6. The water rinsing system of claim 2, wherein the at least one passive passage includes:
a first mixing chamber;
a second mixing chamber;
a first feedback channel fluidly coupled to the first mixing chamber; and
a second feedback channel fluidly coupled to the first mixing chamber and the second mixing chamber.

7. The water rinsing system of claim 6, wherein the at least one passive passage includes:
a lateral channel spacing the first mixing chamber and the second feedback channel.

8. The water rinsing system of claim 6, wherein the at least one passive passage includes:
a third mixing chamber; and
a third feedback channel, wherein the third feedback channel is fluidly coupled to the third mixing chamber and the second mixing chamber.

9. The water rinsing system of claim 2, wherein the at least one passive passage includes:
a first mixing chamber in a first plane; and
a second mixing chamber in a second plane, wherein the first plane is at an angle to the second plane.

10. The water rinsing system of claim 1, further comprising:
a curved or segmented hosing including the fluidic module, wherein the curved or segmented housing is shaped according to the rim of the toilet bowl.

11. The water rinsing system of claim 1, further comprising:
a valve configured to supply water to the water supply in response to a flush cycle.

12. The water rinsing system of claim 11, wherein the valve is actuated by a float.

13. The water rinsing system of claim 11, wherein the valve is actuated electronically.

14. The water rinsing system of claim 1, wherein the water source is a water tank and the water supply is connected to a bottom of the water tank.

15. The water rinsing system of claim 1, wherein the water supply is connected through a rim channel.

16. The water rinsing system of claim 1, wherein the water source is a plumbing system.

17. A method for rinsing a toilet bowl, the method comprising:
supplying water through a bend connector to a fluidic module at a rim of the toilet bowl; and
directing an oscillated flow of water from the fluidic module at a substantially downward angle at the toilet bowl.

18. A toilet comprising:
a water tank;
a toilet bowl;
a water rinsing system for a toilet, the water rinsing system comprising:
a plurality of fluidic modules configured to direct water to the toilet bowl;
a water supply configured to supply water to the plurality of fluidic modules at a rim of the toilet bowl from the water tank; and
a bend connector configured to connect the plurality of fluidic modules and the water supply at an angle to overhang the rim of the toilet bowl.

19. The toilet of claim 18, wherein each of the plurality of fluidic module comprises:
a chamber; and
a feedback channel fluidly coupled to the chamber.

20. The toilet of claim 19, wherein the feedback channel connects at least two of the plurality of fluidic modules.
